(19) United States
(12) Patent Application Publication
(10) Pub. No.: US 2014/0191992 A1
(43) Pub. Date: Jul. 10, 2014

(54) TOUCH INPUT METHOD, ELECTRONIC DEVICE, SYSTEM, AND READABLE RECORDING MEDIUM BY USING VIRTUAL KEYS

(71) Applicant: NATIONAL CHENG KUNG UNIVERSITY, Tainan City (TW)

(72) Inventors: FONG-GONG WU, TAINAN CITY (TW); YU-CHUN HUANG, TAINAN CITY (TW)

(73) Assignee: NATIONAL CHENG KUNG UNIVERSITY, Tainan City (TW)

(21) Appl. No.: 14/136,178

(22) Filed: Dec. 20, 2013

(30) Foreign Application Priority Data
Dec. 21, 2012 (TW) 101148919

(51) Int. Cl. G06F 3/041; G06F 3/0488

(52) U.S. Cl. CPC G06F 3/0416; G06F 3/04886
USPC 345/173

(57) ABSTRACT

A touch input method, system, and readable recording medium of an electronic device. The electronic device has a touch screen. The touch input system contains a processing unit, a database group, a touch-area calculating module, a plurality of touch-area variation analysis modules, and a control module. The method contains steps of: calculating, when a first character graphic key displayed on the touch screen is touched, touch-area data so that a first character corresponding to the first character graphic key is inputted into the electronic device; and acquiring, when the touch-area data is varied, a shift amount and a shift direction of the touch-area data, wherein a second character corresponding to a second character graphic key which is located beside the first character graphic key is inputted into the electronic device when the shift amount reaches a threshold value.

### FIELD OF THE INVENTION

The present invent relates to a touch input method, electronic device, system, and readable recording medium by using virtual keys which selects a desired character by turning a touch means on a touch screen so as to input the desired letter data easily and quickly, wherein the touch input method, the system, and the readable recording medium are applied on an interactive TV, a touch desk, smart glasses, watches, clothing with computation function, and human skin used as a carrier to transmit signals.

### BACKGROUND OF THE INVENTION

Convention electronic device contains a touch screen for inputting letters, wherein the touch screen displays a virtual keyboard so that a user is allowed to touch the virtual key of the virtual keyboard to input a respective letter. Nuance Communications, Inc., a U.S. company, has developed Swype input method. Swype input method is generally installed on Android mobile platform, and it is functioned to judge difference between “target letter” and “path” when an input means is dragged to select desired letters from a virtual QWERT keyboard which is displayed on a touch screen such that the user can input the desired letters without lifting the input means from the touch screen and to correct the target letter with a built-in dictionary.

However, Swype input method still has the following disadvantage:

1. The virtual keys arranged on the virtual QWERT keyboard represents a single letter, and any two adjacent virtual keys are separated by a gap between the two adjacent virtual keys. This arrangement makes the virtual keyboard occupy too much display space on the touch screen and limits the display space of other programs. Therefore, Swype input method is lack of usability in this respect.

2. As dragging selected letters with fingers, a dragging distance is too long to input letters quickly and needs more effort.

Besides, EXideas, Inc., another U.S. company, has developed an input method called MessageEase, it is designed to arrange the letter keys to a keyboard of 3×3 square, wherein the most used letter key is located on a central position of the keyboard, and the other letter keys are arranged on corners of the keyboard or adjacent to a boundary of the keyboard so as to save the required display space of the keyboard. Nevertheless, utilizing MessageEase input method, the user still needs to drag or slide the input means on the touch screen to select the desired letters that costs more effort and has less efficiency for letter input.

The present invention has arisen to mitigate and/or obviate the afore-described disadvantages.

### SUMMARY OF THE INVENTION

The primary object of the present invention is to provide a touch input method, electronic device, system, and readable recording medium which allow a user to select a desired character by tuning their fingers on a touch screen such that the character input is more quick, easy and effort-saving as the user need not to drag or slide his/her finger when select the desired character.

Another object of the present invention is to provide a touch input method, electronic device, system, and readable recording medium, in which the number of graphic keyboard can be decreased to allow the increase of the size of the graphic keyboard such that the accuracy and efficiency of character input is improved and the visible range of the touch screen of the electronic device is enhanced as well.

To obtain the above objective, the present invention provides a method of processing input from a touch screen of an electronic device. The electronic device has a character database which has a plurality of characters collected therein. The plurality of characters includes a first character and a second character. The method comprises steps of: displaying at least one character graphic keyboard on the touch screen, each of the at least one character graphic keyboard including a plurality of character graphic keys, wherein the plurality of character graphic keys includes a first character graphic key corresponding to the first character and a second character graphic key corresponding to the second character, and wherein the second character graphic key is located beside the first character graphic key; receiving, by the touch screen, a touch signal and detecting initial touch-area data when the first character graphic key is touched by an input means, such that the first character is inputted into the electronic device according to the touch signal; detecting, when touching gravity of the input means is shifted toward the second character graphic key, touch-area expanding data in a first direction and touch-area reduction data in a second direction as well with respect to the initial touch-area data, wherein the first direction is toward the second character graphic key and opposite to the second direction; and acquiring a shift amount and a shift direction based on the touch-area expanding data and the touch-area reduction data, wherein the second character is inputted into the electronic device when the shift amount reaches a threshold value.

Preferably, each of the at least one character graphic keyboard includes three character graphic keys, and the three character graphic keys are arranged along an oriented reference line defined on a respective one of the at least one character graphic keyboard. One of the three character graphic keys is located at a central point of the oriented reference line, and the other two character graphic keys are respectively arranged at opposite sides of the character graphic key which is located at the center point of the oriented reference line.

Preferably, each of the at least one character graphic keyboard includes nine character graphic keys, and the nine character graphic keys are arrayed to form a 3×3 square. One of the nine character graphic keys is located at a central point of the 3×3 square, and the other eight character graphic keys are located near a boundary of the at least one character graphic keyboard.

Preferably, the at least one character graphic keyboard is allowed to be moved to any position on the touch screen when the at least one character graphic keyboard is activated by another touch signal and a drag signal.

The present invention further provides an electronic device. The electronic comprises: a touch screen; a memory device storing instructions; and one or more processors to execute the instructions to: calculating, when a first character graphic key displayed on the touch screen is touched, touch-area data so that a first character corresponding to the first character graphic key is inputted into the electronic device; and acquiring, when the touch-area data is varied, a shift amount and a shift direction of the touch-area data, wherein a second character corresponding to a second character graphic key which is located beside the first character graphic key is inputted into the electronic device when the shift amount reaches a threshold value.

The present invention also provides a non-transitory readable recording medium adapted to an electronic device having a touch screen, which comprises one or more instructions, which, when executed by one or more processors, cause the one or more processors to: calculating, when a first character graphic key displayed on the touch screen is touched, touch-area data so that a first character corresponding to the first character graphic key is inputted into the electronic device; and acquiring, when the touch-area data is varied, a shift amount and a shift direction of the touch-area data, wherein a second character corresponding to a second character graphic key which is located beside the first character graphic key is inputted into the electronic device when the shift amount reaches a threshold value.

The present invention yet provides a touch input system adapted for an electronic device. The electronic device has a touch screen, and the touch input system comprises: a processing unit; a database group connecting with the processing unit and including a character database, a touch-area database, and a touch-area variation database, wherein the character database has a plurality of characters collected therein, the plurality of characters including a first character and a second character; at least one character graphic keyboard displayed on the touch screen as a virtual keyboard, the character graphic keyboard including a plurality of character graphic keys, the plurality of character graphic keys including a first character graphic key and a second character graphic key located beside the first character graphic key, wherein when a touch signal is generated to activate the first character graphic key, the processing unit inputs the first character into the electronic device accordingly; a touch-area calculating module, built in the processing unit, for calculating initial touch-area data according to the touch signal and recording the initial touch-area data in the touch-area database; a plurality of touch-area variation analysis modules, wherein, when the initial touch-area data is varied, one of the plurality of touch-area variation analysis modules detects touch-area expanding data in a first direction and records the touch-area expanding data in the touch-area variation database, and another one of the plurality of touch-area variation analysis modules detects a touch-area reduction data in a second direction and records the touch-area reduction data in the touch-area variation database, and wherein the first direction is toward a second character graphic key which is located beside the first character graphic key and opposite to the second direction; a control module, built in the processing unit, for acquiring a shift amount and a shift direction based on the touch-area expanding data and the touch-area reduction data, wherein the processing unit inputs the second character into the electronic device when the shift amount reaches a threshold value.

The present invention still provides a method of processing input from a touch screen of an electronic device, the method comprising steps of: calculating, when a first character graphic key displayed on the touch screen is touched, touch-area data so that a first character corresponding to the first character graphic key is inputted into the electronic device; and acquiring, when the touch-area data is varied, a shift amount and a shift direction of the touch-area data, wherein a second character corresponding to a second character graphic key which is located beside the first character graphic key is inputted into the electronic device when the shift amount reaches a threshold value.

The present invention will become more obvious from the following description when taken in connection with the accompanying drawings which show, for purposes of illustration only, a preferred embodiment in accordance with the present invention

### BRIEF DESCRIPTION OF THE DRAWINGS

FIG. 1 is a diagram of a touch input system according to a preferred embodiment of the present invention.

FIG. 2 is a schematic view showing at least one character graphic keyboard displayed on a touch screen of a smartphone according to the preferred embodiment of the present invention.

FIG. 3 is a schematic view showing at least one character graphic keyboard displayed on a touch screen of a tablet computer according to the preferred embodiment of the present invention.

FIG. 4 is a flow chart showing processing steps of inputting a plurality of characters according to the preferred embodiment of the present invention.

FIG. 5A is a schematic view showing operation of inputting a character G according to the preferred embodiment of the present invention.

FIG. 5B is a schematic view showing operation of inputting a character F according to the preferred embodiment of the present invention.

FIG. 5C is a schematic view showing operation of inputting a character H according to the preferred embodiment of the present invention.

FIG. 6A is a schematic view showing operation of inputting a character S according to the preferred embodiment of the present invention.

FIG. 6B is a schematic view showing operation of inputting a character W according to the preferred embodiment of the present invention.

FIG. 6C is a schematic view showing operation of inputting a character X according to the preferred embodiment of the present invention.

### DETAILED DESCRIPTION OF THE PREFERRED EMBODIMENTS

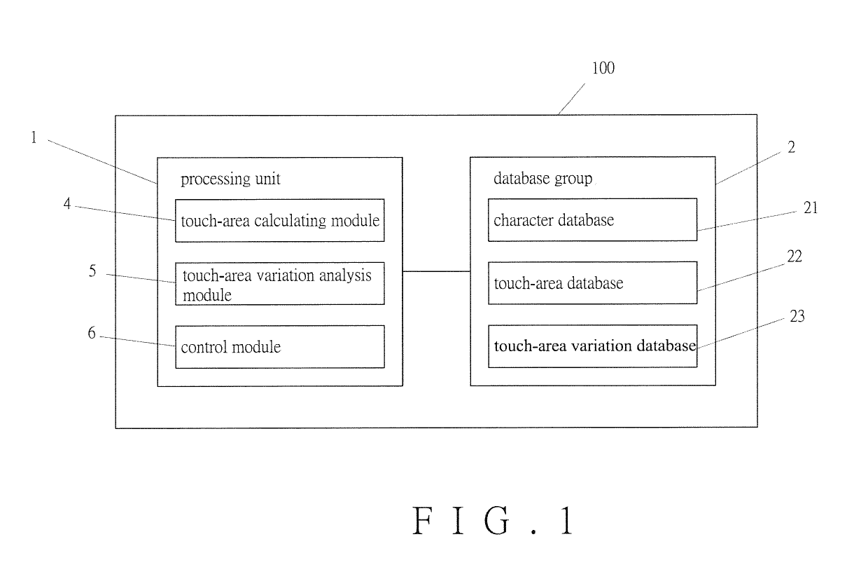

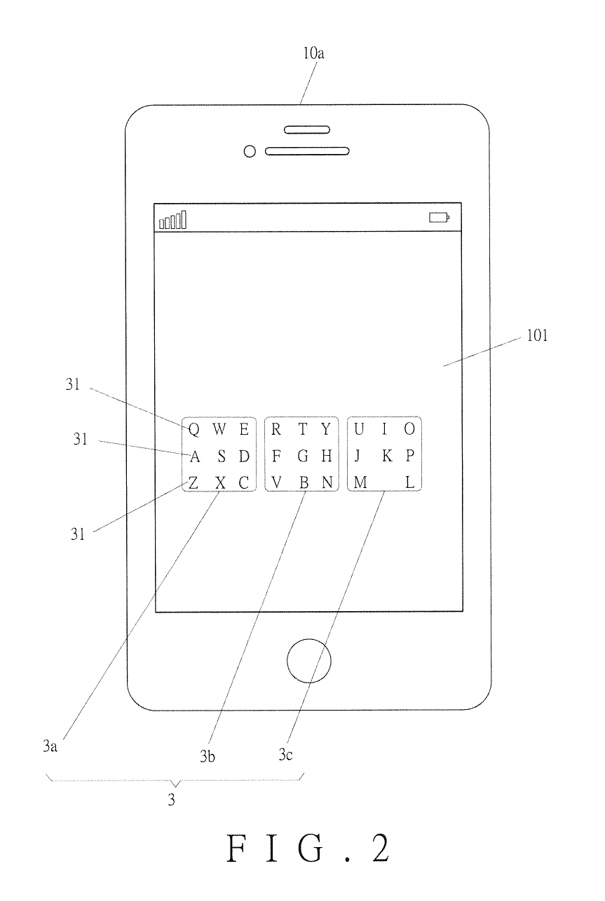

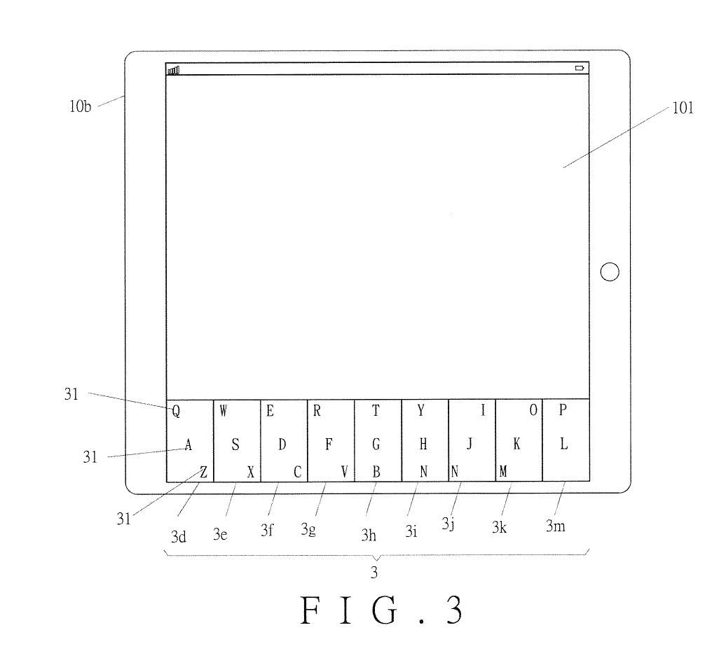

FIG. 1 shows a touch input system 100 in accordance an embodiment of the present invention. The touch input system 100 is applicable for electronic devices (10a, 10b) which have touch screens (101) (shown in FIGS. 2 and 3). The touch input system 100 comprises:
a processing unit 1;
a database group 2 connecting with the processing unit 1 and including a character database 21, a touch-area database 22, and a touch-area variation database 23, wherein the character database 21 includes a plurality of characters collected therein, the plurality of characters include decimal digits 0-9, letters of alphabet A to Z, operational signs and any notation that is processable by the electronic device 10a, 10b; and
at least one character graphic keyboard 3 displayed on the touch screen 101 to as a virtual keyboard and including a plurality of character graphic keys 31 (shown in FIGS. 2 and 3). The plurality of character graphic keys 31 include a first character graphic key 31 and a second character graphic key 31 located beside the first character graphic key 31, and the processing unit 1 inputs a first character into the electronic device 10a, 10b when the first character graphic key 31 is activated by a touch signal. It is to be noted that the touch signal is generated when a user touches the touch screen 101 by using an input means, such as the user's finger or a stylus.

In one embodiment, as shown in FIG. 2, the number of the at least one character graphic keyboard 3 is three, i.e., three character graphic keyboards 3a, 3b, 3c displayed on the touch screen 101, and each of the three character graphic keyboards 3a, 3b, 3c includes nine character graphic keys 31. Preferably, the nine character graphic keys 31 are positioned by a polar coordinates system which is defined on a respective one of the three character graphic keyboards 3a, 3b, 3c. For example, one of the nine character graphic keys 31 is located at a central reference point of the polar coordinates system, and the other eight character graphic keys 31 are arrayed around the character graphic key 31 located at the central reference point of the polar coordinate system so as to form a 3×3 square. This embodiment is adapted for a smart phone 10a by which a user can easily input a desired character with single hand. Preferably, the character graphic keys 31 can be located adjacent to a boundary of the at least one character graphic keyboard 3 such that the limited extent of the at least one character graphic keyboard 3 can accommodate multiple character graphic keys 31 to reduce the required number of the at least one character graphic keyboard 3. Thereby, the size of the at least one character graphic keyboard 3 can be increased to improve the accuracy and efficiency of character input and to enhance a visible range of the touch screen 101 of the smart phone 10a.

In another embodiment, as shown in FIG. 3, the number of the at least one character graphic keyboard 3 is nine, i.e., nine character graphic keyboards 3d, 3e, 3f, 3g, 3h, 3i, 3j, 3k, 3m displayed on the touch screen 101, and each of the nine character graphic keyboards 3d, 3e, 3f, 3g, 3h, 3i, 3j, 3k, 3m includes three character graphic keys 31. Preferably, the three character graphic keys 31 are arranged along an oriented reference line defined on a respective one of the nine character graphic keyboards 3d, 3e, 3f, 3g, 3h, 3i, 3j, 3k, 3m. For example, one of the three character graphic keys 31 is located at a central point of the oriented reference line, and the other two character graphic keys 31 are respectively arranged on opposite sides of the character graphic key 31 located at the central point of the oriented reference line. This embodiment is adapted for a tablet computer 10b by which the user can easily select a desired character graphic key by turning his/her finger at an angle.

The touch input system 100 also comprises a touch-area calculation module 4, built in the processing unit 1, for analyzing initial touch-area data of the touch signal and recording the initial touch-area data in the touch-area database 22. It is to be noted that the term “touch-area” herein means the area, on the touch screen, which is touched by the input means. Further, the term “touch-area data” means the data generated according to the “touch area”.

The touch input system 100 further comprises a plurality of touch-area variation analysis modules 5, wherein, one of the plurality of touch-area variation analysis modules 5 is provided to detect touch-area expanding data in a first direction with respect to the initial touch-area data when the user turns the input means from the first character graphic key 31 toward the second character graphic key 31 and to record the touch-area expanding data in the touch-area variation database 23, and another one of the plurality of touch-area variation analysis modules 5 is provided to detect touch-area reduction data in a second direction with respect to the initial touch-area data when the user turns the input means from the first character graphic key31 toward the second character graphic key 31 and to record the touch-area reduction data in the touch-area variation database 23, and wherein the first direction is toward the second character graphic key 31 and opposite to the second direction; and a control module 6, built in the processing unit 1, for acquiring a shift amount and a shift direction based on the touch-area expanding data and the touch-area reduction data, and the processing unit 1 generates a control signal when the shift amount reaches a threshold value, and wherein the threshold value can be adjusted by users according to their usage habits.

When in use, the at least one character graphic keyboard 3 displayed on the touch screen 101 is allowed to be dragged to any position on the touch screen 101, such as a central position of the touch screen or two inner sides of the touch screen 101 so that the user can touch the at least one character graphic keyboard 3 with two hands to operate the electronic device 10a, 10b.

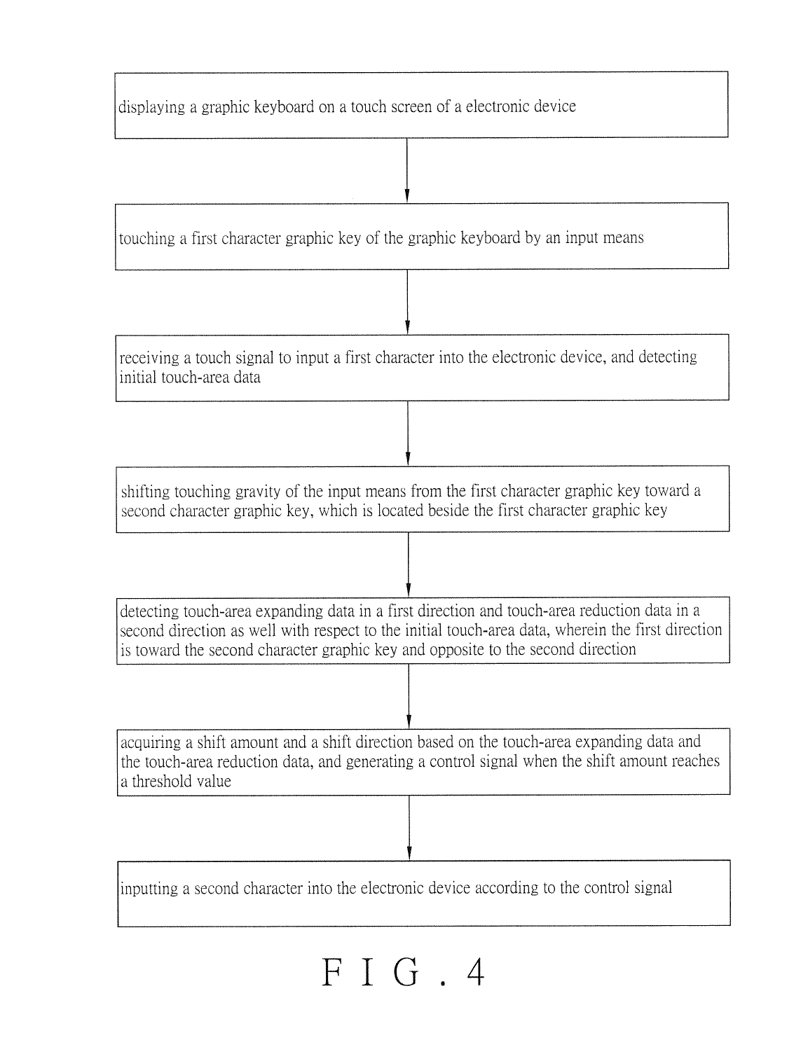

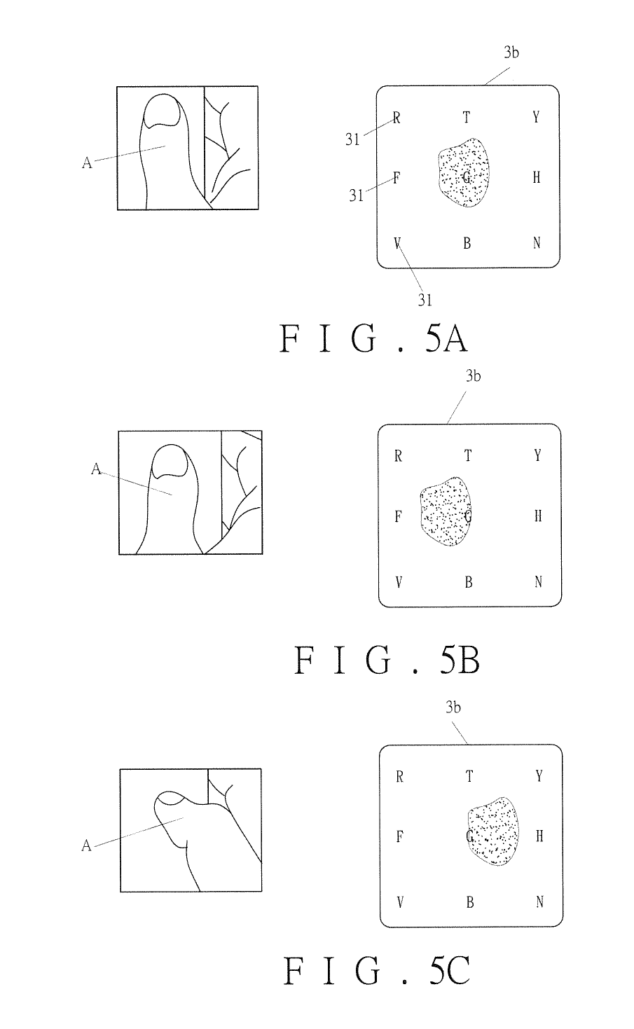

Specifically, as illustrated in FIG. 4 and FIGS. 5A to 5C, the user uses a touch means A to touch one of the plurality of character graphic keys 31. It is to be noted that the touch means A has a deformable part, and that the deformable part of the touch means A can be made of any material that is capable of generating different flexible deformations when a force is applied to turn the touch means A at different angles, while the touch means A illustrated in FIGS. 5A to 5C is the user's finger. For example, the deformable part of the touch means A can be made of rubber. Further, the term “turn” herein means to provide a force to make a means, such as the input means A, lightly tilt toward a specific direction. Thus, when the input means A in touch with the touch screen 101 is turned, the touching gravity thereof is shifted and the deformable part thereof is further deformed to shift the touch-area at the same time.

More specifically, when the user touches the character graphic key 31 of which is displayed on the touch screen 101 of the electronic device 10a in FIG. 2 by using a touch means A (as shown in FIG. 5A) to generate a touch signal, a character “G” can be directly inputted into the electronic device 10a, and thereafter the touch-area calculating module 4 analyzes initial touch-area data according to the touch signal received by the touch screen 101 and records the initial touch-area data into the touch-area database 22.

Subsequently, to input a character “F”, the user only needs to turn the touch means A toward the character graphic key 31 of “F” to shift the touching gravity of the touch means A toward the same (as shown in FIG. 5B) such that one of the plurality of touch-area variation analysis modules 5 detects touch-area expanding data in a direction which is toward the character graphic key 31 of “F”, and another one of the plurality of touch-area variation analysis modules 5 detects touch-area reduction data in an opposite direction. Thereafter, the control module 6 acquires a shift amount and a shift direction based on the touch-area expanding data and the touch-area reduction data, and a character “F” is inputted into the electronic device 10a when the shift amount and direction reach a threshold value.

Likewise, to input a character “H” after the input of the character “G”, the user only needs to turn the touch means A toward the character graphic key 31 of “H” to shift the touching gravity of the touch means A toward the same (as shown in FIG. 5C) such that one of the plurality of touch-area variation analysis modules 5 detects touch-area expanding data in a direction which is toward the character graphic key 31 of “H”, and another one of the plurality of touch-area variation analysis modules 5 detects touch-area reduction data in an opposite direction. Thereafter, the control module 6 acquires a shift amount and a shift direction based on the touch-area expanding data and the touch-area reduction data, and a character “H” is inputted into the electronic device 10a when the shift amount and direction reach a threshold value.

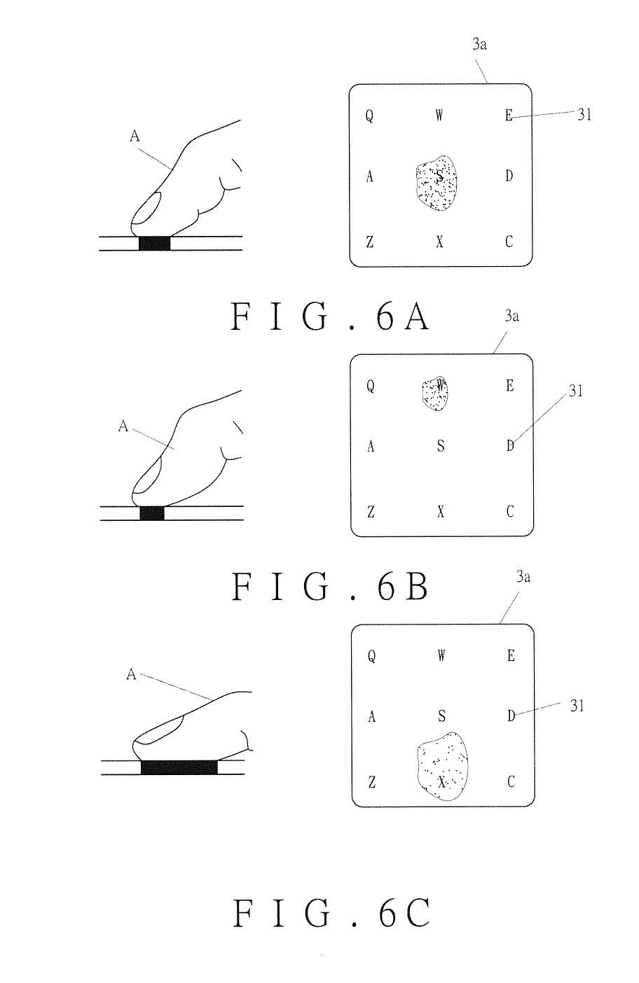

Similarly, when the user touches the character graphic key 31 of “S” which is displayed on the touch screen 101 of the electronic device 10a in FIG. 2 by using the touch means A (as shown in FIG. 6A) to generate a touch signal, a character “S” can be directly inputted into the electronic 10a, and thereafter the touch-area calculating module 4 analyzes initial touch-area data according to the touch signal received by the touch screen 101 and records the initial touch-area data into the touch-area database 22.

Subsequently, to input a character “W”, the user only needs to turn the touch means A toward the character graphic key 31 of “W” to shift the touching gravity of the touch means A toward the same (as shown in FIG. 6B) such that one of the plurality of touch-area variation analysis modules 5 detects touch-area expanding data in a direction which is toward the character graphic key 31 of “W”, and another one of the plurality of touch-area variation analysis modules 5 detects touch-area reduction data in an opposite direction. Thereafter, the control module 6 acquires a shift amount and a shift direction based on the touch-area expanding data and the touch-area reduction data, and a character “W” is inputted into the electronic device 10a when the shift amount and direction reach a threshold value.

Likewise, to input a character “X” after the input of the character “S”, the user only needs to turn the touch means A toward the character graphic key 31 of “X” to shift the touching gravity of the touch means A toward the same (as shown in FIG. 6C) such that one of the plurality of touch-area variation analysis modules 5 detects touch-area expanding data in a direction which is toward the character graphic key 31 of “X”, and another one of the plurality of touch-area variation analysis modules 5 detects touch-area reduction data in an opposite direction. Thereafter, the control module 6 acquires a shift amount and a shift direction based on the touch-area expanding data and the touch-area reduction data, and a character “X” is inputted into the electronic device 10a when the shift amount and direction reach a threshold value.

Accordingly, the user can easily and quickly select a desired character by turning the input means A, and the efficiency of character input and the usability of the touch screen are both improved.

Preferably, processing steps executed by the touch input system 100 can be constructed as a program that is stored in as non-transitory readable recording medium (not shown) which is readable by the electronic device 10a, 10b. It is to be noted that the electronic 10a, 10b is not limited to be a smart phone or a tablet computer, for example, the electronic device 10a, 10b also can be a personal digital assistant (PDA), an interactive TV, a touch desk, smart glasses, a watch, or other devices which have a touch control interface. Preferably, the program also can be applied to clothing which have computation function or to utilize human skin as a carrier to transmit signals. Moreover, the program can be stored in a server so that the user can download the program online.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of processing input from a touch screen of an electronic device, the electronic device having a character database which has a plurality of characters collected therein, the plurality of characters including a first character and a second character, the method comprising steps of:
displaying at least one character graphic keyboard on the touch screen, each of the at least one character graphic keyboard including a plurality of character graphic keys, wherein the plurality of character graphic keys includes a first character graphic key corresponding to the first character and a second character graphic key corresponding to the second character, and wherein the second character graphic key is located beside the first character graphic key;
receiving, by the touch screen, a touch signal and detecting initial touch-area data when the first character graphic key is touched by an input means, such that the first character is inputted into the electronic device according to the touch signal;
detecting, when touching gravity of the input means is shifted toward the second character graphic key, touch-area expanding data in a first direction and touch-area reduction data in a second direction as well with respect to the initial touch-area data, wherein the first direction is toward the second character graphic key and opposite to the second direction; and
acquiring a shift amount and a shift direction based on the touch-area expanding data and the touch-area reduction data, wherein the second character is inputted into the electronic device when the shift amount reaches a threshold value.

2. The method as claimed in claim 1, wherein each of the at least one character graphic keyboard includes three character graphic keys, and the three character graphic keys are arranged along an oriented reference line defined on a respective one of the at least one character graphic keyboard, and wherein one of the three character graphic keys is located at a central point of the oriented reference line, and the other two character graphic keys are respectively arranged at opposite sides of the character graphic key which is located at the center point of the oriented reference line.

3. The method as claimed in claim 1, wherein each of the at least one character graphic keyboard includes nine character graphic keys, and the nine character graphic keys are arrayed to form a 3×3 square, and wherein one of the nine character graphic keys is located at a central point of the 3×3 square, and the other eight character graphic keys are located near a boundary of the at least one character graphic keyboard.

4. The method as claimed in claim 1, wherein the at least one character graphic keyboard is allowed to be moved to any position on the touch screen when the at least one character graphic keyboard is activated by another touch signal and a drag signal.

5. An electronic device, comprising:
a touch screen;
a memory device storing instructions; and
one or more processors to execute the instructions to:
calculating, when a first character graphic key displayed on the touch screen is touched, touch-area data so that a first character corresponding to the first character graphic key is inputted into the electronic device; and
acquiring, when the touch-area data is varied, a shift amount and a shift direction of the touch-area data, wherein a second character corresponding to a second character graphic key which is located beside the first character graphic key is inputted into the electronic device when the shift amount reaches a threshold value.

6. A non-transitory readable recording medium adapted to an electronic device having a touch screen, comprising the instructions as claimed in claim 5.

7. A touch input system adapted for an electronic device, the electronic device having a touch screen, the touch input system comprising:
a processing unit;
a database group connecting with the processing unit and including a character database, a touch-area database, and a touch-area variation database, wherein the character database has a plurality of characters collected therein, the plurality of characters including a first character and a second character;
at least one character graphic keyboard displayed on the touch screen as a virtual keyboard, the character graphic keyboard including a plurality of character graphic keys, the plurality of character graphic keys including a first character graphic key and a second character graphic key located beside the first character graphic key, wherein when a touch signal is generated to activate the first character graphic key, the processing unit inputs the first character into the electronic device accordingly;
a touch-area calculating module, built in the processing unit, for calculating initial touch-area data according to the touch signal and recording the initial touch-area data in the touch-area database;
a plurality of touch-area variation analysis modules, wherein, when the initial touch-area data is varied, one of the plurality of touch-area variation analysis modules detects touch-area expanding data in a first direction and records the touch-area expanding data in the touch-area variation database, and another one of the plurality of touch-area variation analysis modules detects a touch-area reduction data in a second direction and records the touch-area reduction data in the touch-area variation database, and wherein the first direction is toward a second character graphic key which is located beside the first character graphic key and opposite to the second direction;
a control module, built in the processing unit, for acquiring a shift amount and a shift direction based on the touch-area expanding data and the touch-area reduction data, wherein the processing unit inputs the second character into the electronic device when the shift amount reaches a threshold value.

8. A method of processing input from a touch screen of an electronic device, the method comprising steps of:
calculating, when a first character graphic key displayed on the touch screen is touched, touch-area data so that a first character corresponding to the first character graphic key is inputted into the electronic device; and
acquiring, when the touch-area data is varied, a shift amount and a shift direction of the touch-area data, wherein a second character corresponding to a second character graphic key which is located beside the first character graphic key is inputted into the electronic device when the shift amount reaches a threshold value.
